(19) United States
(12) Patent Application Publication
(10) Pub. No.: US 2010/0158445 A1
(43) Pub. Date: Jun. 24, 2010

(54) FLEXIBLE WAVEGUIDE STRUCTURE AND OPTICAL INTERCONNECTION ASSEMBLY

(75) Inventors: Min-Su Kim, Daejeon (KR); Jong-Moo Lee, Daejeon (KR); Suntak Park, Daejeon (KR); Jung Jin Ju, Daejeon (KR); Jin Tae Kim, Daejeon (KR); Seung Koo Park, Daejeon (KR); Joong-Seon Choe, Daejeon (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon (KR)

(21) Appl. No.: 12/545,459

(22) Filed: Aug. 21, 2009

(30) Foreign Application Priority Data
Dec. 23, 2008 (KR) 10-2008-0131865

(51) Int. Cl. G02B 6/36; G02B 6/036; G02B 6/10

(52) U.S. Cl. 385/53; 385/126; 385/130

(57) ABSTRACT

Provided are a flexible waveguide structure and an optical interconnection assembly. The flexible waveguide structure includes a thin film strip core, an inner cladding layer, and an outer cladding layer. The thin film strip core has opposed first and second surfaces and is formed of a metal. The inner cladding layer covers at least one of the first and second surfaces of the thin film strip core. The outer cladding layer covers the inner cladding layer. The inner cladding layer has a refractive index higher than that of the outer cladding layer.

### CROSS-REFERENCE TO RELATED APPLICATIONS

This U.S. non-provisional patent application claims priority under 35 U.S.C. §119 of Korean Patent Application No. 10-2008-0131865, filed on Dec. 23, 2008, the entire contents of which are hereby incorporated by reference.

### BACKGROUND

The present invention disclosed herein relates to a flexible waveguide structure and an optical interconnection assembly, and more particularly, to a flexible waveguide structure and an optical interconnection assembly configured to minimize degradation of signal quality caused by bending.

To satisfy high signal transmission and processing rate requirements of mobile devices, a multi-layer flexible electrical wiring module in which several tens of electrical signal channels are arranged in parallel has been used in a mobile system. Due to electromagnetic interference proportional to the mounting density of devices, existing electrical wiring modules have limitations in satisfying consistent demands for higher signal transmission rates.

To overcome these limitations of existing electrical wiring modules, active research is being conducted on flexible optical wiring constituted by polymer multi-mode optical waveguides and applications of the flexible optical wiring to mobile devices. However, optical interconnection structures using optical waveguides should be further improved in many aspects such as process simplification for cost reduction, efficient alignment with active optical devices, and optical and mechanical flex resistance sufficient for applications to mobile systems.

### SUMMARY

The present invention provides a flexible waveguide structure configured to reduce additional optical loss caused by bending, and an optical interconnection assembly including the flexible waveguide structure.

Embodiments of the present invention provide flexible waveguide structures including: a thin film strip core having opposed first and second surfaces and formed of a metal; an inner cladding layer covering at least one of the first and second surfaces of the thin film strip core; and an outer cladding layer covering the inner cladding layer, wherein the inner cladding layer has a refractive index higher than that of the outer cladding layer.

In some embodiments, a difference between the refractive indexes of the inner and outer cladding layers may be equal to or greater than about 0.1% of the refractive index of the outer cladding layer.

In other embodiments, the thin film strip core may be configured to transmit light by a phenomenon related to surface plasmon polaritons or surface exciton polaritons.

In still other embodiments, the thin film strip core may include at least one material of silver (Ag), gold (Au), aluminum (Al), and copper (Cu), or an alloy or mixture thereof.

In even other embodiments, the thin film strip core may have a thickness in a range from about 5 nm to about 100 nm, and the thin film strip core may have a width in a range from about 0.5 μm to about 50 μm.

In further embodiments, at least one of the inner and outer cladding layers may include a flexible optical polymer.

In still further embodiments, the thin film strip core may be surrounded by the inner cladding layer.

In even further embodiments, one of the first and second surfaces of the thin film strip core may make contact with the inner cladding layer, and the other of the first and second surfaces makes contact with the outer cladding layer.

In yet further embodiments, the thin film strip core may include a coupling part connected to an end of the thin film strip core, and the coupling part has a width varying in a direction away from the end of the thin film strip core.

In some embodiments, the thin film strip core may include a coupling part connected to an end of the thin film strip core, and the coupling part may be divided into two or more branches within a range of a single optical guided mode.

In other embodiments, the thin film strip core may include a plurality of thin film strips that are configured to transmit a single optical guided mode.

In still other embodiments, the thin film strip core may be divided into two or more parts each transmitting the same optical signal separately.

In even other embodiments, the flexible waveguide structure may further include an additional cladding layer or a structural supporting layer configured to cover the outer cladding layer entirely or partially.

In other embodiments of the present invention, optical interconnection assemblies include: the flexible waveguide structure; an optical transmission module disposed at an end of the flexible waveguide structure; and an optical receiving module disposed at the other end of the flexible waveguide structure.

In some embodiments, the optical transmission module may include a first semiconductor chip and an optical emitter, and the optical receiving module may include a second semiconductor chip and an optical receiver.

In still other embodiments of the present invention, flexible optical and electrical wiring modules include: the flexible waveguide structure; and an electrical interconnection structure combined with the flexible waveguide structure.

In some embodiments, optical and electrical interconnection assemblies include: the flexible optical and electrical wiring module; an optical and electrical transmission module disposed at an end of the flexible optical and electrical wiring module; and an optical and electrical receiving module disposed at the other end of the flexible optical and electrical wiring module, wherein the flexible waveguide structure transmits an optical signal between the optical and electrical transmission module and the optical and electrical receiving module, and the electrical interconnection structure transmits an electrical signal between the optical and electrical transmission module and the optical and electrical receiving module.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIGS. 1 through 3 illustrate a flexible waveguide structure according to an embodiment of the present invention;

FIGS. 4 through 6 illustrate various structures for cladding a thin film strip core according to embodiments of the present invention;

FIG. 7 illustrates a flexible waveguide structure according to another embodiment of the present invention;

FIGS. 8 through 10 illustrate various structures for improving the coupling efficiency or coupling configuration of a flexible waveguide structure according to embodiments of the present invention;

FIG. 11 illustrates a flexible waveguide structure according to another embodiment of the present invention;

FIG. 12 illustrates a flexible waveguide structure incorporating a structural supporting layer according to an embodiment of the present invention; and

FIG. 13 illustrates an optical and electrical interconnection assembly according to an embodiment of the present invention.

### DETAILED DESCRIPTION OF PREFERRED EMBODIMENTS

Preferred embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

It will be understood that although the terms first and second are used herein to describe various elements, these elements should not be limited by these terms. These terms are only used to distinguish one element from another element.

In the figures, the dimensions of layers and regions are exaggerated for clarity of illustration, and like reference numerals refer to like elements throughout.

In the present disclosure, several embodiments are exemplarily explained to provide understanding of the spirit and scope of the present invention, and various modifications and changes thereof are not explained for conciseness. However, it will be understood by those of ordinary skill in the art that various modifications and changes in form and details may be made therein without departing from the spirit and scope of the present invention.

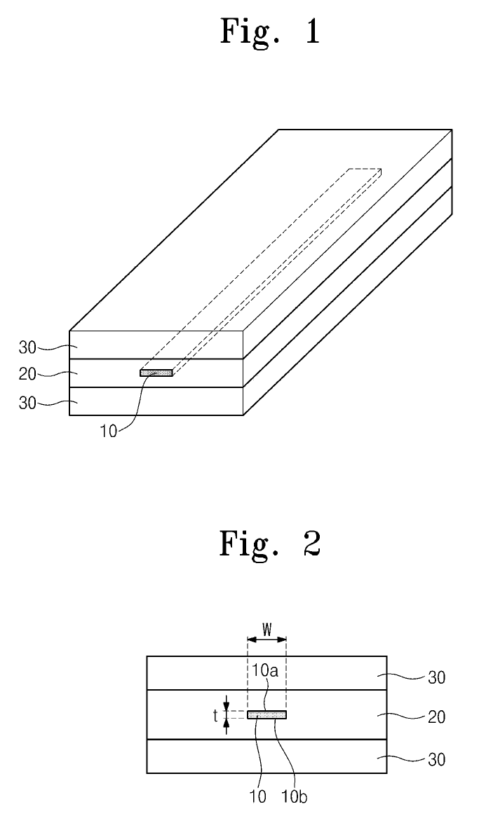

FIGS. 1 through 3 illustrate a flexible waveguide structure according to an embodiment of the present invention.

Referring to FIGS. 1 and 2, the flexible waveguide structure includes a thin film strip core 10, an inner cladding layer 20, and outer cladding layers 30. The thin film strip core 10 has first surface 10a and second surface 10b that are opposite to each other, and the thin film strip core 10 is formed of a metal. The inner cladding layer 20 covers at least one of the first and second surfaces 10a and 10b of the thin film strip core 10. The outer cladding layers 30 cover the inner cladding layer 20. The inner cladding layer 20 has a refractive index higher than that of the outer cladding layers 30.

The thin film strip core 10 can transmit light by a phenomenon related to surface plasmon polaritons (SPPs) or surface exciton polaritons. The term “surface plasmon” means a charge density oscillation occurring at an interface between a dielectric and a metal thin film. A metal thin film may substantially form a metal island structure rather than being in a thin film shape when the metal thin film is very thin at about several nanometers, and the term “surface exciton” means a charge distribution oscillation in the metal island structure. The term “surface plasmon polaritons” or “surface exciton polaritons” mean an electromagnetic wave coupled with surface plasmons or surface excitons and propagating along a metal surface. In the following description, the term “surface plasmon polaritons” will be used as a representative of the two terms for conciseness.

Since the wave vector of a surface plasmon polariton mode is greater than a wave vector transmitted by a neighboring dielectric material, surface plasmon polaritons are transmitted in the form of an electromagnetic wave confined in the vicinity of a metal thin film. When an electric field of a surface plasmon polariton mode propagates along an interface between a dielectric and a metal, a large portion of the electric field propagates through the metal as well as the dielectric. Therefore, generally, the propagation loss of a surface plasmon polariton mode is very large, and thus the surface plasmon polariton mode propagates only about several tens of micrometers in a visible light region. However, in a coupled mode where surface plasmon polaritons propagating along both sides of a very thin metal film are superimposed, the surface plasmon polaritons can travel several centimeters to several tens of centimeters. This mode is called long-range surface plasmon polaritons (LRSPPs).

The thin film strip core 1O may be formed of one or more metals. For example, the thin film strip core 1O may be formed of one of silver (Ag), gold (Au), aluminum (Al), and copper (Cu), or an alloy or mixture including at least one of the listed metals. Generally, the refractive index of a metal has a large imaginary part. That is, metals absorb a large portion of incident light. However, in the case of the thin film strip core 1O, most energy of a surface plasmon polariton mode is transferred through the inner cladding layer 20 instead of being transferred through the thin film strip core 10, and thus loss caused by absorption of a metal is low. Therefore, the propagation loss of the flexible waveguide structure can be reduced to a value less than 1 dB/cm.

The thickness of the thin film strip core 10 (indicated by t in FIG. 2) is adjusted so that surface plasmon polariton modes generated at the first surface 10a and the second surface 10b can be coupled to each other. For example, the thickness of the thin film strip core 10 may be about 5 nm to about 100 nm. If the thin film strip core 10 is formed of gold (Au) or silver (Ag), the thickness of the thin film strip core 10 is several or several tens of nanometers at an optical communication wavelength band.

The width of the thin film strip core 10 (indicated by w in FIG. 2) may be determined based on the coupling efficiency of an optical interconnection between the flexible waveguide structure and an optical transmission device or optical receiving device, and the propagation loss of the flexible waveguide structure. For example, the width of the thin film strip core 10 may be about 0.5 μm to about 50 μm.

The refractive index difference between the inner cladding layer 20 and the outer cladding layers 30 may be determined by evaluating mode distribution characteristics and bending loss characteristics based on the thicknesses, structures, and arrangement of the thin film strip core 10 and the other layers. For example, the refractive index difference between the inner cladding layer 20 and the outer cladding layers 30 may be equal to or greater than 0.1% of the refractive index of the outer cladding layers 30. For instance, the refractive indexes of the inner cladding layer 20 may be about 1.46, and the refractive index of the outer cladding layers 30 may be about 1.45. If necessary, the upper and lower outer cladding layers 30 may have different refractive indexes. In this case, the refractive index difference between the inner cladding layer 20 and the outer cladding layers 30 may also be equal to or greater than 0.1% of the refractive index of any one of the outer cladding layers 30. At least one of the inner cladding layer 20 and the outer cladding layers 30 may be formed of a flexible optical polymer. For example, the flexible optical polymer may be a low-loss optical polymer obtained by substituting hydrogen atoms of a typical optical polymer with atoms of a halogen such as fluorine or deuterium atoms.

With reference to FIG. 3, it will now be described how the flexible waveguide structure can have low bending loss when it is bent vertically. If the inner cladding layer 20 is not provided, the optical power of a surface plasmon polariton mode propagating along the thin film strip core 10 can be uselessly dissipated in the direction of arrow □. However, according to the present invention, since the refractive index of the inner cladding layer 20 is greater than that of the outer cladding layers 30, the optical power of a surface plasmon polariton mode may not be dissipated at the interfaces between the inner cladding layer 20 and the outer cladding layers 30 but may propagate in the direction of arrow □. That is, owing to the inner cladding layer 20, surface plasmon polaritons can be confined with less dissipation to the outer cladding layers 30.

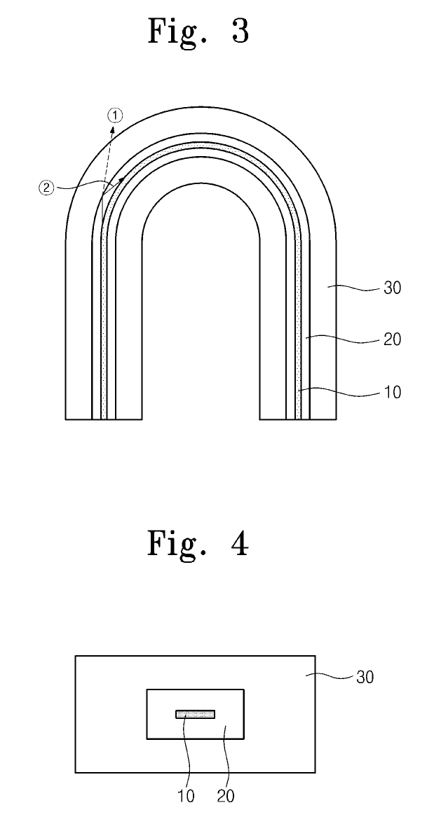

With reference to FIGS. 4 through 6, explanations will be given on various methods of cladding a thin film strip core. Referring to FIG. 4, a thin film strip core 10 is surrounded by an inner cladding layer 20 and the inner cladding layer 20 is surrounded by an outer cladding layer 30. In the case shown in FIG. 4, bending loss can be minimized in all directions.

Referring to FIG. 5, a first surface 10a of a thin film strip core 10 makes contact with an inner cladding layer 20, and a second surface 10b of the thin film strip core 10 makes contact with an outer cladding layer 30. In the case of a flexible waveguide structure shown in FIG. 5, which of the first and second surfaces 10a and 10b is located outward has no significant influence on minimizing the bending loss of the flexible waveguide structure. Referring to FIG. 6, an inner cladding layer 20 enclosing a thin film strip core 10 may have an extension. That is, a portion of the inner cladding layer 20 enclosing the thin film strip core 10 may be thicker than the other portions of the inner cladding layer 20.

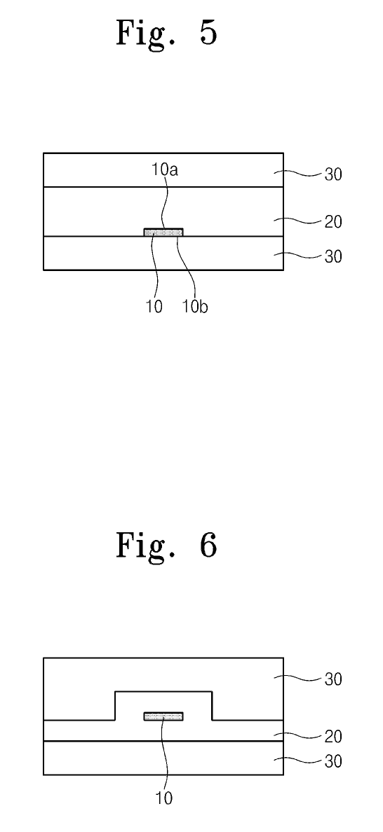

FIG. 7 illustrates a flexible waveguide structure according to another embodiment of the present invention. The current embodiment is similar to the above-described embodiments except for additional cladding layers. Thus, descriptions of the same elements will be omitted. The flexible waveguide structure of the current embodiment includes an inner cladding layer 20 enclosing a thin film strip core 10, outer cladding layers 30 covering the inner cladding layer 20, and additional cladding layers 40 configured to cover the outer cladding layers 30 entirely or partially. The refractive index of the outer cladding layers 30 may be greater than that of the additional cladding layers 40. However, in the case where a sufficiently bound mode to the thin film strip core 10 can be obtained according to the refractive index difference between the inner cladding layer 20 and the outer cladding layers 30 and heights of the respective layers, the additional cladding layers 40 may be formed of a material having an refractive index greater than that of the outer cladding layers 30. Owing to the additional cladding layers 40, the important part of the flexible waveguide structure can be less damaged, and in some cases, the vertical bending loss of the flexible waveguide structure can be further reduced because the optical loss related to the radiation to the outer cladding layers 30 can be prevented by the additional cladding layers 40.

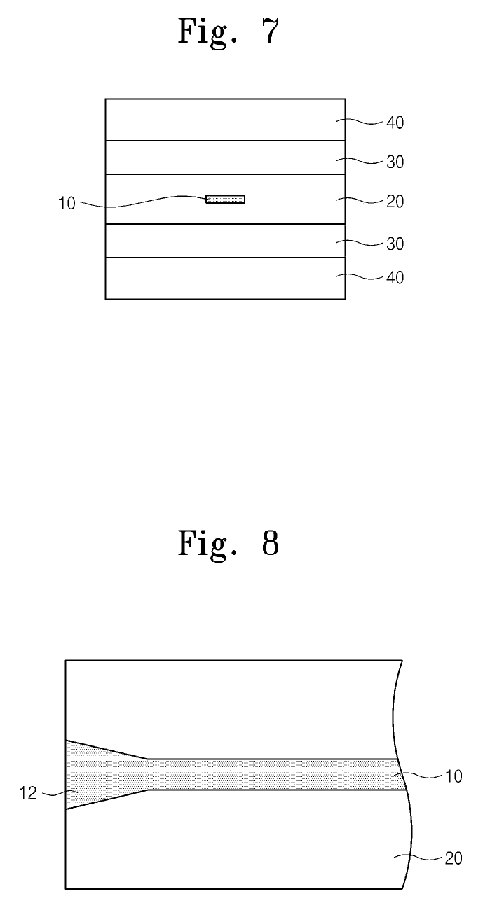

FIGS. 8 through 10 illustrate various structures for improving the coupling efficiency or coupling configuration of a flexible waveguide structure according to embodiments of the present invention.

Referring to FIG. 8, a thin film strip core 10 may include a structure for improving the coupling efficiency between the flexible waveguide structure and an optical transmission or receiving device. The thin film strip core 10 may include a coupling part 12 connected to an end of the straight part of the thin film strip core 10. The width of the coupling part 12 may vary as it goes away from the end of the thin film strip core 10 according to coupling conditions with an optical transmission or receiving device. In some cases, the coupling part 12 may be placed between two different parts of the thin film strip core 10 with respective widths.

Referring to FIG. 9, the thin film strip core 10 may include a multi-branch coupling part 14 so as to increase the mode size of a surface plasmon polariton mode or to transmit or receive a plurality of optical signals at the same time. In detail, the multi-branch coupling part 14 may be divided into a plurality of branches on the same plane. The branches of the multi-branch coupling part 14 may be spaced from each other in a manner such that surface plasmon polaritons of the respective branches can be coupled to form a combined mode. As a result, an optical signal can be output with an increased mode size owing to the multi-branch coupling part 14 shown in FIG. 9. Referring to FIG. 10, a coupling part 15 may have a Y-branch structure to output the same optical signal at two separate positions. Unlike the structure of the multi-branch coupling part 14 of FIG. 9, branches of the coupling part 15 of FIG. 10 are sufficiently spaced from each other to prevent coupling between surface plasmon polaritons of the respective branches, and thus two same optical signals can be output separately.

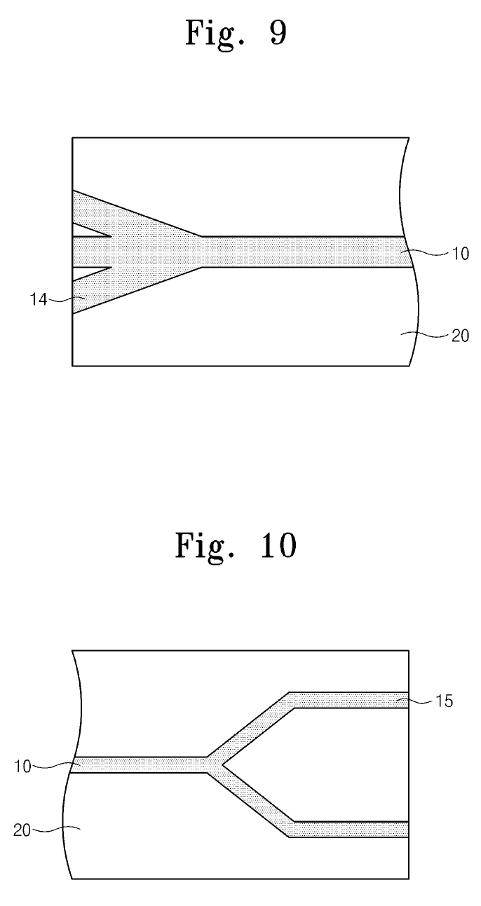

FIG. 11 illustrates a flexible waveguide structure according to another embodiment of the present invention. Referring to FIG. 11, a plurality of thin strips 16 may form a structure for a thin film strip core. The number of the thin strips 16 may be two, four, or any other number. For example, if the thin film strip core includes two thin strips 16, surface plasmon polaritons generated at the thin strips 16 may be coupled to each other and transmitted along the thin film strip core as a long-range surface plasmon polariton mode. In the case where the thin film strip core includes more than two thin strips 16, a long-range surface plasmon polariton mode can be transmitted in a similar way to the above-described way.

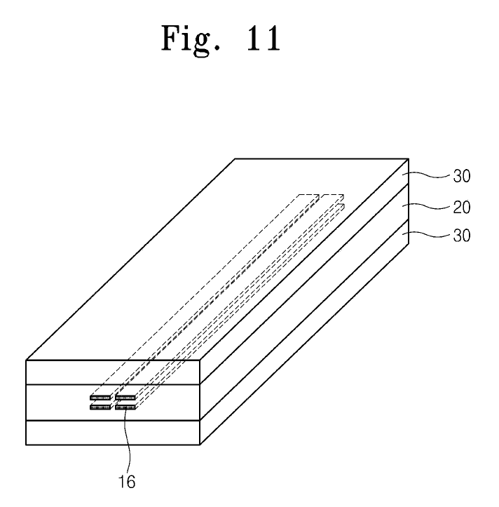

FIG. 12 illustrates a flexible waveguide structure incorporating a structural supporting layer according to an embodiment of the present invention. Referring to FIG. 12, the flexible waveguide structure further includes a supporting layer 50 attached to both sides of the bottom surface of the basic part of the flexible waveguide structure. In this case, the flexible waveguide structure can be easily handled and coupled with an optical transmission device and/or an optical receiving device.

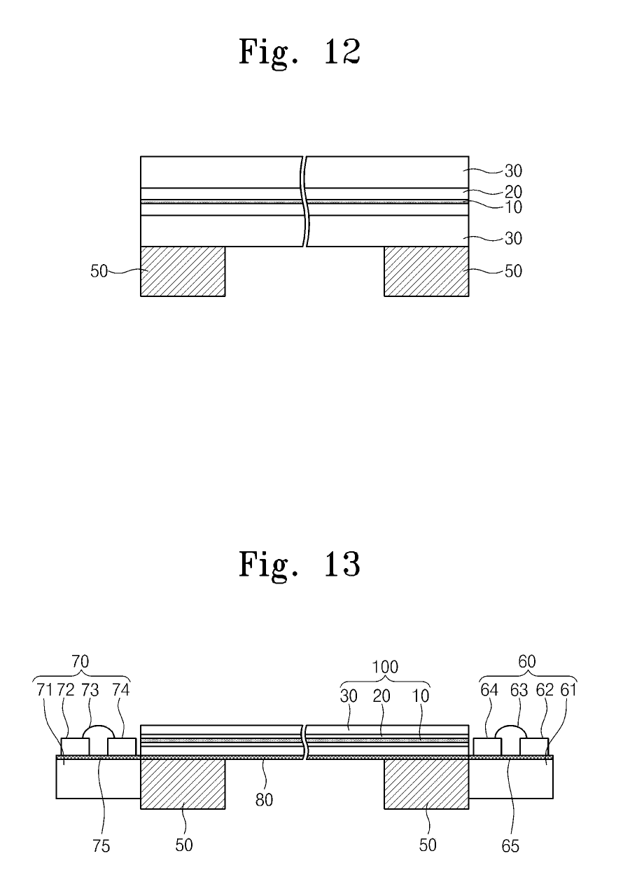

FIG. 13 illustrates an optical and electrical interconnection assembly according to an embodiment of the present invention. Referring to FIG. 13, as described above, a flexible waveguide structure 100 includes a thin film strip core 10, an inner cladding layer 20, and outer cladding layers 30. An optical transmission module 70 is coupled to an end of the flexible waveguide structure 100, and an optical receiving module 60 is coupled to the other end of the flexible waveguide structure 100. A supporting layer 50 may be attached to the flexible waveguide structure 100. The optical transmission module 70 may include a first semiconductor chip 72 and an optical emitter 74 that are disposed on a first substrate 71. The first semiconductor chip 72 and the optical emitter 74 may be electrically connected through a first electric wire 73. The first substrate 71 may be a semiconductor substrate. The optical emitter 74 may be a laser diode. The first semiconductor chip 72 may include a bipolar transistor based on silicon-germanium or other materials.

Instead of the optical emitter 74 and the first semiconductor chip 72, any other devices having corresponding functions may be used.

The optical receiving module 60 may include a second semiconductor chip 62 and an optical detector (optical receiver) 64 that are disposed on a second substrate 61. The second semiconductor chip 62 and the optical detector 64 may be electrically connected through a second electric wire 63. The optical emitter 74 may convert an electric signal received from the first semiconductor chip 72 into an optical signal, and the optical signal may be transmitted to the optical detector 64 through the flexible waveguide structure 100.

The flexible waveguide structure 100 of the optical and electrical interconnection assembly may further include an electrical interconnection structure 80. The electrical interconnection structure 80 may be disposed inside the flexible waveguide 100, at a surface of the outer cladding layers 30, at a surface of an additional structure, or at an interface between the additional structure and the outer cladding layers 30. Alternatively, the electrical interconnection structure 80 may be formed by connecting structures disposed at different layers through various connection structures such as sloped surfaces or via holes. The electrical interconnection structure 80 may be connected to an electric wire or circuit 75 disposed at the optical transmission module 70 and an electric wire or circuit 65 disposed at the optical receiving module 60, so as to transmit an electrical signal independently of an optical signal propagating through the flexible waveguide structure 100. That is, a high-speed signal may be transmitted through the flexible waveguide structure 100, and a relatively low-speed signal or electric power may be transmitted through the electrical interconnection structure 80. Since the flexible waveguide structure 100 has a minimized bending loss, the flexible waveguide structure 100 can be bent if necessary.

According to the embodiments of the present invention, the flexible waveguide structure has low vertical bending loss and high mechanical stability owing to its multi-layer cladding structure. The optical interconnection assembly including the flexible waveguide structure can be used with less signal quality degradation and mechanical degradation in severe bending and deformation conditions occurred inside next-generation high-speed mobile devices.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A flexible waveguide structure comprising:
a thin film strip core having opposed first and second surfaces and formed of a metal;
an inner cladding layer covering at least one of the first and second surfaces of the thin film strip core; and
an outer cladding layer covering the inner cladding layer,
wherein the inner cladding layer has a refractive index higher than that of the outer cladding layer.

2. The flexible waveguide structure of claim 1, wherein a difference between the refractive indexes of the inner and outer cladding layers is equal to or greater than about 0.1% of the refractive index of the outer cladding layer.

3. The flexible waveguide structure of claim 1, wherein the thin film strip core is configured to transmit light by a phenomenon related to surface plasmon polaritons or surface exciton polaritons.

4. The flexible waveguide structure of claim 1, wherein the thin film strip core comprises at least one of silver (Ag), gold (Au), aluminum (Al), and copper (Cu), or an alloy or mixture thereof.

5. The flexible waveguide structure of claim 1, wherein the thin film strip core has a thickness in a range from about 5 nm to about 100 nm.

6. The flexible waveguide structure of claim 1, wherein the thin film strip core has a width in a range from about 0.5 μm to about 50 μm.

7. The flexible waveguide structure of claim 1, wherein at least one of the inner and outer cladding layers comprises a flexible optical polymer.

8. The flexible waveguide structure of claim 1, wherein the thin film strip core is surrounded by the inner cladding layer.

9. The flexible waveguide structure of claim 1, wherein one of the first and second surfaces of the thin film strip core is in contact with the inner cladding layer, and the other of the first and second surfaces is in contact with the outer cladding layer.

10. The flexible waveguide structure of claim 1, wherein the thin film strip core comprises a coupling part connected to an end of the thin film strip core, and the coupling part has a width varying in a direction away from the end of the thin film strip core.

11. The flexible waveguide structure of claim 1, wherein the thin film strip core comprises a coupling part connected to an end of the thin film strip core, and the coupling part is divided into two or more branches within a range of a single optical guided mode.

12. The flexible waveguide structure of claim 1, wherein the thin film strip core comprises a plurality of thin film strips that are configured to transmit a single optical guided mode.

13. The flexible waveguide structure of claim 1, wherein the thin film strip core is divided into two or more parts each transmitting the same optical signal separately.

14. The flexible waveguide structure of claim 1, further comprising an additional cladding layer or a structural supporting layer configured to cover the outer cladding layer entirely or partially

15. An optical interconnection assembly comprising:
the flexible waveguide structure of claim 1;
an optical transmission module disposed at an end of the flexible waveguide structure; and
an optical receiving module disposed at the other end of the flexible waveguide structure.

16. The optical interconnection assembly of claim 15, wherein the optical transmission module comprises a first semiconductor chip and an optical emitter, and
the optical receiving module comprises a second semiconductor chip and an optical receiver.

17. A flexible optical and electrical wiring module comprising:
the flexible waveguide structure of claim 1; and
an electrical interconnection structure combined with the flexible waveguide structure.

18. An optical and electrical interconnection assembly comprising:
the flexible optical and electrical wiring module of claim 17;
an optical transmission module disposed at an end of the flexible optical and electrical wiring module; and
an optical receiving module disposed at the other end of the flexible optical and electrical wiring module,
wherein the flexible waveguide structure transmits an optical signal between the optical transmission module and the optical receiving module, and the electrical interconnection structure transmits an electrical signal between the optical transmission module and the optical receiving module.
